(19) United States
(12) Patent Application Publication
(10) Pub. No.: US 2026/0212355 A1
(43) Pub. Date: Jul. 23, 2026

(54) FIRST ELECTRONIC DEVICE FOR GENERATING SMART CONTRACT SET TO PERFORM WALLET FUNCTION, OPERATING METHOD THEREOF, AND SECOND ELECTRONIC DEVICE FOR PERFORMING CRYPTOCURRENCY TRANSACTION BY USING SAME SMART CONTRACT

(71) Applicant: SAMSUNG ELECTRONICS CO., LTD., Suwon-si (KR)

(72) Inventor: Gyubok MOON, Suwon-si (KR)

(73) Assignee: SAMSUNG ELECTRONICS CO., LTD., Suwon-si (KR)

(21) Appl. No.: 19/566,574

(22) Filed: Mar. 13, 2026

Related U.S. Application Data
(63) Continuation of application No. PCT/KR2024/013967, filed on Sep. 13, 2024.

(30) Foreign Application Priority Data
Sep. 15, 2023 (KR) 10-2023-0123470
Dec. 4, 2023 (KR) 10-2023-0173801

(51) Int. Cl. G06Q 20/40; G06Q 20/36; G06Q 20/38

(52) U.S. Cl. CPC G06Q 20/401; G06Q 20/36; G06Q 20/382; G06Q 2220/00

(57) ABSTRACT

A first electronic device to receive from a second electronic device, through the communication circuitry, a first registration request for an address associated with a cryptocurrency transaction and first authentication information of the second electronic device. The first electronic device to generate a first address associated with the second electronic device to transact cryptocurrency, based on receiving the first registration request and the first authentication information. The first electronic device to transmit, through the communication circuitry to a blockchain network, first transaction information including the first address, the first authentication information, and an address associated with the first electronic device for supporting the cryptocurrency transaction. The first electronic device to transmit registration information including the first address and a blockchain address of the first smart contract to the second electronic device through the communication circuitry, based on identifying that the first smart contract has been created on the blockchain network.

### CROSS-REFERENCE TO RELATED APPLICATIONS

This application is a continuation of International Application No. PCT/KR 2024/013967, filed on Sep. 13, 2024, which is based on and claims priority to Korean Provisional Patent Application No. 10-2023-0123470, filed on Sep. 15, 2023, in the Korean Intellectual Property Office, and Korean Provisional Patent Application No. 10-2023-0173801, filed on Dec. 12, 2023, in the Korean Intellectual Property Office, the disclosures of which are incorporated by reference herein in their entireties.

### BACKGROUND

### 1. Field

This disclosure relate to a first electronic device creating a smart contract configured to perform a wallet function, and a second electronic device performing cryptocurrency transaction using the smart contract.

### 2. Description of Related Art

Since the rise of blockchain-based bitcoin's popularity, blockchain based applications have grown in various sectors, such as smart contract-based platform services or non-fungible token (NFT), cloud storage services, blockchain computing services, as well as electronic currency (cryptocurrency or virtual currency) systems, e.g., bitcoin.

A blockchain platform allows system participants (nodes) to distribute and store data in their respective blocks, which is substantially free from data forgery and falsification (reliability). This allows the participants to own their distributed information (transparency), with no need for a separate central server manager.

The background technology described above is technical information that the inventor possessed for deriving the disclosure or acquired in the process of deriving the disclosure and therefore cannot necessarily be considered as prior art publicly disclosed before the filing of the disclosure.

### SUMMARY

According to one or more embodiments, a first electronic device including: communication circuitry; at least one processor; and memory storing instructions. The instructions, when executed by the at least one processor individually or collectively, cause the electronic device to: receive from a second electronic device, through the communication circuitry, a first registration request for an address associated with a cryptocurrency transaction and first authentication information of the second electronic device; generate a first address associated with the second electronic device to transact cryptocurrency, based on receiving the first registration request and the first authentication information; and transmit, through the communication circuitry to a blockchain network, first transaction information including the first address, the first authentication information, and an address associated with the first electronic device for supporting the cryptocurrency transaction. The first transaction information is used to create a first smart contract configured to perform a wallet function on the blockchain network. The instructions, when executed by the at least one processor individually or collectively, cause the electronic device to: transmit registration information including the first address and a blockchain address of the first smart contract to the second electronic device through the communication circuitry, based on identifying that the first smart contract has been created on the blockchain network.

According to one or more embodiments, a method of operating a first electronic device, including: receiving from a second electronic device a first registration request for an address associated with a cryptocurrency transaction and first authentication information of the second electronic device; generating a first address associated with the second electronic device to transact cryptocurrency, based on receiving the first registration request and the first authentication information; transmitting transaction information including the first address, the first authentication information, and an address associated with the first electronic device for supporting the cryptocurrency transaction to a blockchain network, the transaction information is used to create a first smart contract configured to perform a wallet function on the blockchain network; and transmitting registration information including the first address and a blockchain address associated with the first smart contract to the second electronic device, based on identifying that the first smart contract has been created on the blockchain network.

According to one or more embodiments, an electronic device 302 may include memory 380, a communication circuitry 390, and a processor 370. According to one or more embodiments, the processor may be configured to identify transaction information for cryptocurrency transaction. According to one or more embodiments, the processor may be configured to identify authentication information designated to the electronic device based on a user input. According to one or more embodiments, the processor may be configured to transmit the transaction information, an address for the electronic device to transact the cryptocurrency, and the authentication information to a blockchain network 305 storing a first smart contract 310 configured to perform a wallet function. According to one or more embodiments, when the address of the electronic device and the authentication information are identified by the first smart contract to match information pre-stored in the first smart contract, the cryptocurrency transaction may be completed by the smart contract. According to one or more embodiments, the cryptocurrency transaction may be performed based on the blockchain address and a private key of the smart contract.

### BRIEF DESCRIPTION OF THE DRAWINGS

FIG. 1 is a view illustrating an electronic device in a network environment according to one or more embodiments;

FIG. 2A is a view illustrating a method in which an electronic device records transaction information in a blockchain network and transacts cryptocurrency, according to a one or more embodiments;

FIG. 2B is a view illustrating a method in which an electronic device records transaction information in a blockchain network and transacts cryptocurrency, according to one or more embodiments;

FIG. 3 is a block diagram illustrating a system including a first electronic device, a second electronic device, and a blockchain network, according to one or more embodiments;

FIG. 4 is a flowchart illustrating a method in which a first electronic device creates a first smart contract, according to one or more embodiments;

FIG. 5 is a view illustrating a method in which a first electronic device creates a first smart contract on a blockchain network, according to one or more embodiments;

FIG. 6 is a view illustrating a first smart contract configured to perform a wallet function, according to one or more embodiments;

FIG. 7 is a flowchart illustrating a method in which a first electronic device adds an address of a new electronic device for transacting cryptocurrency using a first smart contract to the first smart contract, according to one or more embodiments;

FIG. 8 is a flowchart illustrating a method in which a first electronic device adds an address of a new electronic device supporting cryptocurrency transaction to a first smart contract, according to one or more embodiments;

FIG. 9 is a flowchart illustrating a method in which a second electronic device transacts cryptocurrency using a first smart contract, according to one or more embodiments; and

FIG. 10 is a view illustrating a method in which a second electronic device transacts cryptocurrency using a first smart contract, according to one or more embodiments.

### DETAILED DESCRIPTION

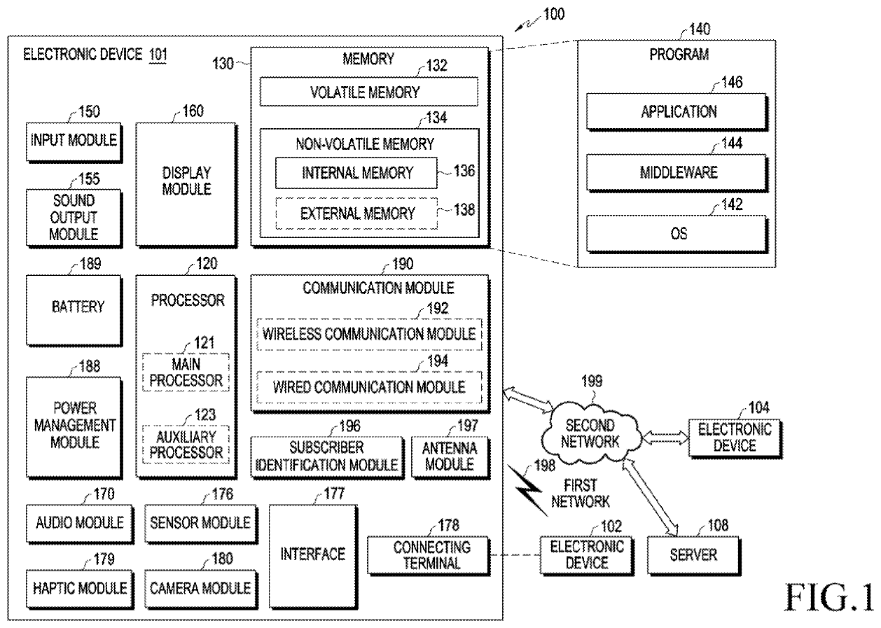

FIG. 1 is a block diagram illustrating an electronic device 101 in a network environment 100, according to various embodiments. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wiredly) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth^{TM}, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

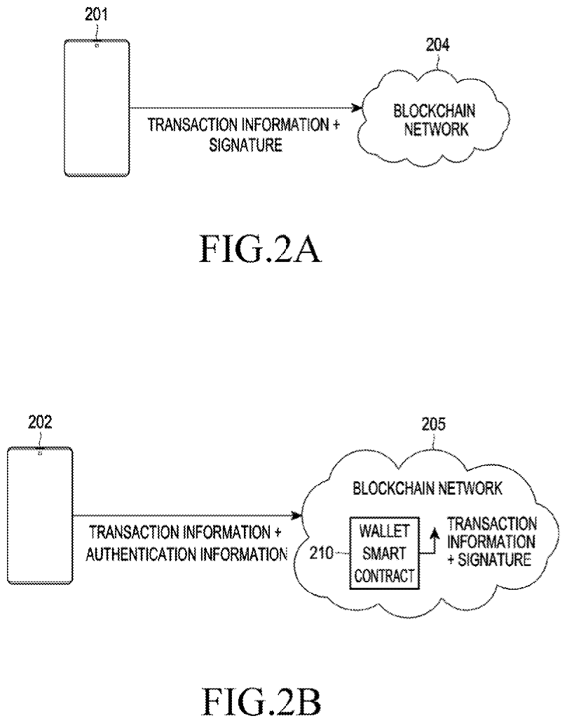

FIG. 2A is a view illustrating a method in which an electronic device records transaction information in a blockchain network and transacts cryptocurrency, according to one or more embodiments.

Referring to FIG. 2A, according to one or more embodiments, an electronic device 201 may perform a function of a blockchain electronic wallet (e.g., cold wallet). In one or more embodiments, an application configured to perform a function of a blockchain electronic wallet may be installed on the electronic device 201. The electronic device 201 may perform a function of a blockchain electronic wallet (e.g., cold wallet) utilizing the application.

According to one or more embodiments, the electronic device 201 may transfer cryptocurrency to a designated blockchain address or account. However, an embodiment of the disclosure is not limited thereto, and the electronic device 201 may also request transfer of cryptocurrency to a specific blockchain address or account. In one or more embodiments, a blockchain address may refer to an identifier (or identification information) that is opened for a user designated in a blockchain network 204 and may access transaction information stored in a server 208 or nodes of the blockchain network 204. In one or more embodiments, the blockchain address (or account) may be the address corresponding to the account of cryptocurrency.

The blockchain address (or account) may correspond to or be generated from a public key among a public key/private key pair generated through several stages from a root seed. The electronic device 201 may digitally sign transaction information (or transaction data) using a private key paired with a public key associated with the address (or account) and transmit the transaction information to the blockchain network 204 when a new transaction occurs.

Transferring cryptocurrency may be different from transferring to a general bank account. In one or more embodiments, transferring cryptocurrency may refer to an operation of digitally signing transaction information (or transaction data) including a receiving address, a sending address, and information related to transfer. The information related to the transfer may include information on funds to be moved, an address of a smart contract processing assets to be moved, a quantity, and a sum of selected balances. The transaction information may be signed with a private key related to the sending address and recording the transaction information in nodes of the blockchain network 204.

A blockchain electronic wallet (e.g., cold wallet) may allow a user to manage security information (e.g., private key) for wallet recovery. Using the security information, a user (or owner) of the blockchain electronic wallet may control and manage cryptocurrency assets. Further, the user may recover the blockchain electronic wallet or manage (e.g., transfer) cryptocurrency assets at any time using the security information.

However, since an operation of recovering a blockchain electronic wallet depends on security information (e.g., private key) directly managed by the user, there may be a risk of cryptocurrency assets being lost when the security information is lost or leaked. To prevent this, the security information may be entrusted to a specific company, but a risk such as hacking or business suspension may occur at the specific company.

A blockchain electronic wallet may only allow a user (or owner) to initiate a transaction. Accordingly, joint management of cryptocurrency assets may be difficult. Accordingly, a method in which a plurality of electronic devices of the user jointly manage cryptocurrency assets may be needed.

FIG. 2B is a view illustrating a method in which an electronic device records transaction information in a blockchain network and transacts cryptocurrency, according to one or more embodiments.

Referring to FIG. 2B, according to one or more embodiments, an electronic device 202 may initiate a cryptocurrency transaction using a smart contract 210 configured to perform a wallet function and stored in nodes included in a blockchain network 205. In one or more embodiments, the electronic device 202 may transmit an address designated to the electronic device 202 (e.g., an address for the electronic device 202 to transact cryptocurrency), transaction information for a transaction, and authentication information to the blockchain network 205. At least one node (e.g., a pre-designated node or a builder node) among nodes included in the blockchain network 205 may call the smart contract 210 upon identifying the transaction information. The smart contract 210 may add or store a new block recording the transaction information in nodes included in the blockchain network 205 when it is identified that the authentication information matches pre-designated authentication information. In one or more embodiments, the smart contract 210 may add or store the new block recording the transaction information in nodes included in the blockchain network 205 using the blockchain address of the smart contract 210 and a signature based on the private key of the smart contract 210. In one or more embodiments, the blockchain address of the smart contract 205 may be different from the address designated to the electronic device 202 (e.g., the address for the electronic device 202 to transact cryptocurrency). When the transaction information is stored in nodes included in the blockchain network 205, the cryptocurrency transaction corresponding to the transaction information may be completed.

According to one or more embodiments, the electronic device 202 may initiate a cryptocurrency transaction using the smart contract 210 without the blockchain address of the blockchain network 205 and a signature based on the private key. To this end, a plurality of electronic devices including the electronic device 202 may create, recover, or change an address for transacting cryptocurrency in a mutually complementary manner. In one or more embodiments, one electronic device (e.g., a first electronic device 202) among the plurality of electronic devices may perform cryptocurrency transaction using an address for the cryptocurrency transaction. The one electronic device (e.g., the first electronic device 202) may request a cryptocurrency transaction from the smart contract 210 configured to perform a wallet function using the address. Another electronic device among the plurality of electronic devices may recover or change an address for cryptocurrency transaction using an address for supporting cryptocurrency transaction. The another electronic device may register (e.g., add or update) an address for cryptocurrency transaction in the smart contract 210 configured to perform a wallet function using the address.

Through the above-described method, even when the owner of cryptocurrency assets loses the security information (e.g., private key) or the security information is leaked, the cryptocurrency assets may be managed. Mutually complementary operations related to cryptocurrency transaction performed by the plurality of electronic devices is described below in greater detail.

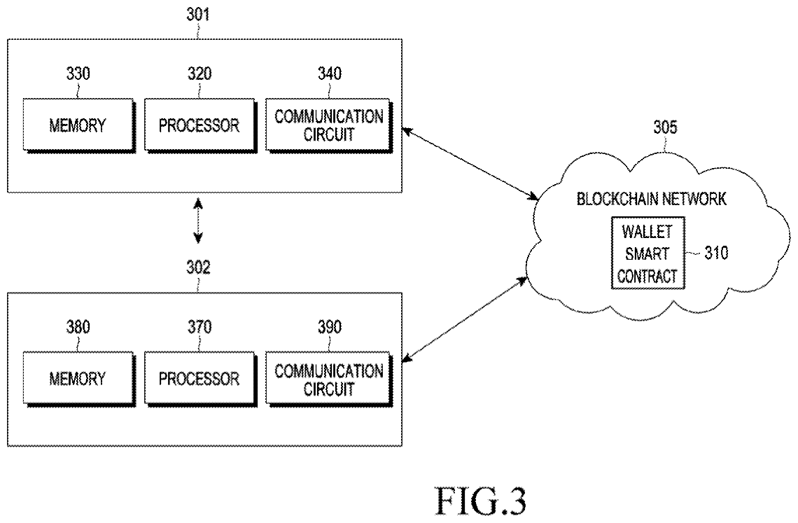

FIG. 3 is a block diagram illustrating a system including a first electronic device, a second electronic device, and a blockchain network, according to one or more embodiments.

Referring to FIG. 3, according to one or more embodiments, a first electronic device 301 may include a processor 320, memory 330, and communication circuitry 340. The processor 320 may be embodied as one or more processors. In one or more embodiments, the first electronic device 301 may be implemented identically or similarly to the electronic device 101, 102, or 104 of FIG. 1.

According to one or more embodiments, the first electronic device 301 may perform a function for supporting cryptocurrency transaction (e.g., support role) and/or a function of generating an address for a cryptocurrency transaction. The function of generating an address for a cryptocurrency transaction may also be included in the function for supporting a cryptocurrency transaction. In one or more embodiments, the function of generating an address for a cryptocurrency transaction may include a function of generating an address through which another electronic device (e.g., the second electronic device 302) may transact cryptocurrency. According to one or more embodiments, the first electronic device 301 may continuously generate a new address through which another electronic device (e.g., the second electronic device 302) may transact cryptocurrency. For example, the first electronic device 301 may store an application for supporting cryptocurrency transaction (e.g., a decentralized recoverable wallet (DRW) application) in the memory 330. The first electronic device 301 may perform a function for supporting cryptocurrency transaction using the application.

According to one or more embodiments, the processor 320 may control the overall operation of the first electronic device 301. In one or more embodiments, the processor 320 may be implemented identically or similarly to the processor 120 of FIG. 1.

According to one or more embodiments, the processor 320 may execute instructions to perform a function related to supporting cryptocurrency transaction so that the second electronic device 302 may initiate cryptocurrency transaction.

According to one or more embodiments, the processor 320 may execute instructions to request creation of a smart contract 310 (hereinafter, first smart contract) configured to perform a wallet function on the blockchain network 305 through the communication circuitry 340 (e.g., the communication module 190 of FIG. 1).

According to one or more embodiments, the processor 320 may execute instructions to generate a first address for the second electronic device 302 to initiate cryptocurrency transaction when a request from the second electronic device 302 (e.g., a request to register an address for cryptocurrency transaction in the first smart contract) is received and identified. In one or more embodiments, the first address may be different from a blockchain address for actually initiating a transaction in the blockchain network 305. According to one or more embodiments, the processor 320 may execute instructions to generate the first address based on an address format (or address form) used in the blockchain network 305. In one or more embodiments, the processor 320 may execute instructions to generate the first address having a random value according to the address format (or address form) used in the blockchain network 305.

According to one or more embodiments, the first electronic device 301 may receive authentication information (or identification information) of the second electronic device 302 from the second electronic device 302. In one or more embodiments, the authentication information may be information for identifying the second electronic device 302 or a user of the second electronic device 302. In one or more embodiments, the authentication information (or identification information) may include various types of information for identifying the second electronic device 302 or the user of the second electronic device 302. For example, the authentication information may include pre-designated data, a pre-designated value (e.g., a PIN number), a pre-designated pattern, and/or biometric information of the user (e.g., fingerprint information or iris information).

According to one or more embodiments, the processor 320 may execute instructions to generate an address of the first electronic device 301. In one or more embodiments, the address of the first electronic device 301 may be an address used to register, recover, add, or change an address for cryptocurrency transaction in the first smart contract 310. In one or more embodiments, the address of the first electronic device 301 may be different from a blockchain address for actually initiating a transaction in the blockchain network 305. According to one or more embodiments, the processor 320 may execute instructions to generate the address of the first electronic device 301 based on the address format (or address form) used in the blockchain network 305. For example, the processor 320 may execute instructions to generate the address of the first electronic device 301 having a random value according to the address format (or address form) used in the blockchain network 305.

According to one or more embodiments, the first electronic device 301 may request creation of the first smart contract 310 by transmitting the authentication information received from the second electronic device 302, the first address, and the address of the second electronic device 302 to the blockchain network 305 through the communication circuitry 340.

According to one or more embodiments, the processor 320 may identify that the first smart contract 310 is created on the blockchain network 305. For example, the processor 320 may identify that the first smart contract 310 is created on the blockchain network 305 by accessing the blockchain network 305 through the communication circuitry 340. Alternatively, the processor 320 may identify that the first smart contract 310 is created on the blockchain network 305 through information (e.g., information indicating that the first smart contract 310 is created) received from the blockchain network 305.

According to one or more embodiments, the first electronic device 301 may transmit registration information including the first address and the blockchain address of the first smart contract 310 (e.g., information for actually initiating a transaction) to the second electronic device 302 through the communication circuitry 340 when it is identified that the first smart contract 310 is created on the blockchain network 305 by accessing the blockchain network 305.

According to one or more embodiments, the processor 320 may execute instructions to generate a new address for the second electronic device 302 or another electronic device (e.g., a third electronic device) to initiate cryptocurrency transaction when a request from the second electronic device 302 (e.g., a request to register a new address for cryptocurrency transaction in the first smart contract 310) or a request from another electronic device (e.g., a third electronic device) (e.g., a request to register a new address for cryptocurrency transaction in the first smart contract 310) is received and identified. Further, the processor 320 may add the new address to the first smart contract 310. When the new address is added to the first smart contract 310, the electronic device (e.g., the second electronic device 302 or the other electronic device) may initiate cryptocurrency transaction using the new address.

According to one or more embodiments, the processor 320 may execute instructions to generate a new address for another electronic device (e.g., a fourth electronic device) to perform a function related to supporting cryptocurrency transaction when a request from the other electronic device (e.g., the fourth electronic device) (e.g., a request to register a new address for supporting cryptocurrency transaction in the first smart contract 310) is received and identified. Further, the processor 320 may add the new address to the first smart contract 310. When the new address is added to the first smart contract 310, the electronic device (e.g., the fourth electronic device) may perform a function related to supporting cryptocurrency transaction using the new address.

According to one or more embodiments, a second electronic device 302 may include a processor 370, memory 380, and communication circuitry 390. The processor 370 may be embodied as one or more processors. For example, the second electronic device 302 may be implemented identically or similarly to the electronic device 101, 102, or 104 of FIG. 1.

According to one or more embodiments, the second electronic device 302 may perform a function for cryptocurrency transaction (e.g., active role). In one or more embodiments, the second electronic device 302 may store an application for cryptocurrency transaction (e.g., a decentralized recoverable wallet (DRW) application) in the memory 380. The second electronic device 302 may perform a function of initiating cryptocurrency transaction using the application.

According to one or more embodiments, the processor 370 may execute instructions to control the overall operation of the second electronic device 302. For example, the processor 370 may be implemented identically or similarly to the processor 120 of FIG. 1.

According to one or more embodiments, the second electronic device 302 may obtain the first address and the blockchain address of the first smart contract 310 from the first electronic device 301. The second electronic device 302 may transmit transaction information for initiating cryptocurrency transaction, the first address, and authentication information designated to the first electronic device 301 to the blockchain network 305 through the communication circuitry 390 (e.g., the communication module 190 of FIG. 1). At least one node (e.g., a pre-designated node) among nodes included in the blockchain network 305 may call the first smart contract 310 upon identifying the transaction information. The first smart contract 310 may add or store a new block recording the transaction information in nodes included in the blockchain network 305 when it is identified that the first address and the authentication information transmitted from the second electronic device 302 match pre-stored information. Accordingly, a transaction corresponding to the transaction information may occur in the blockchain network 305.

According to one or more embodiments, the blockchain network 305 may include a plurality of nodes (e.g., various types of electronic devices). In one or more embodiments, the blockchain network 305 may be implemented as various types or forms of blockchain networks. The first smart contract 310 configured to perform a blockchain wallet function may be stored in each of the plurality of nodes. For example, at least one node (e.g., a designated node) among the plurality of nodes may call the first smart contract 310 based on transaction information transmitted from the first electronic device 301 or the second electronic device 302. Thereafter, the first smart contract 310 may perform a function corresponding to the transaction information transmitted from the first electronic device 301 or the second electronic device 302.

At least some of operations of the first electronic device 301 described below may be performed by the processor 320. Further, at least some of operations of the second electronic device 302 may be performed by the processor 370. However, for convenience of description, the subjects of the operations are described as the first electronic device 301 and the second electronic device 302.

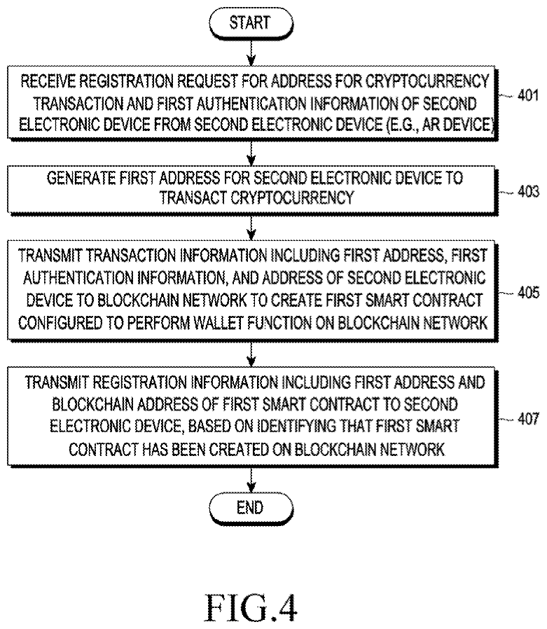

FIG. 4 is a flowchart illustrating a method in which a first electronic device creates a first smart contract, according to one or more embodiments.

According to one or more embodiments, in operation 401, a first electronic device (e.g., the first electronic device 301 of FIG. 3, a support role (SR) device, or a device generating an address for cryptocurrency transaction) may receive a registration request for an address for cryptocurrency transaction and first authentication information of the second electronic device from a second electronic device (e.g., the second electronic device 302 of FIG. 3, an active role (AR) device, or a device requesting cryptocurrency transaction). For example, the first authentication information may represent authentication information (or identification information) designated to the second electronic device 302.

According to one or more embodiments, in operation 403, the first electronic device 301 may generate a first address for the second electronic device 302 to transact cryptocurrency. For example, the first address may be different from a blockchain address for actually initiating a transaction in the blockchain network 305.

According to one or more embodiments, in operation 405, the first electronic device 301 may transmit transaction information including the first address, the first authentication information, and an address of the second electronic device to the blockchain network 305 to create a first smart contract (e.g., the first smart contract 310 of FIG. 3) configured to perform a cryptocurrency wallet function on a blockchain network (e.g., the blockchain network 305 of FIG. 3).

According to one or more embodiments, in operation 407, the first electronic device 301 may transmit registration information including the first address and the blockchain address of the first smart contract to the second electronic device 302, based on identifying that the first smart contract 310 has been created on the blockchain network 305.

According to the above-described method, the first electronic device 301 may create the first smart contract 310 configured to perform a cryptocurrency wallet function on the blockchain network 305. In other words, the first electronic device 301 may create the first smart contract 310 on the blockchain network 305 through which the second electronic device 302 may initiate cryptocurrency transaction without security information (e.g., private key). Accordingly, the second electronic device 302 may initiate cryptocurrency transaction without security information (e.g., private key).

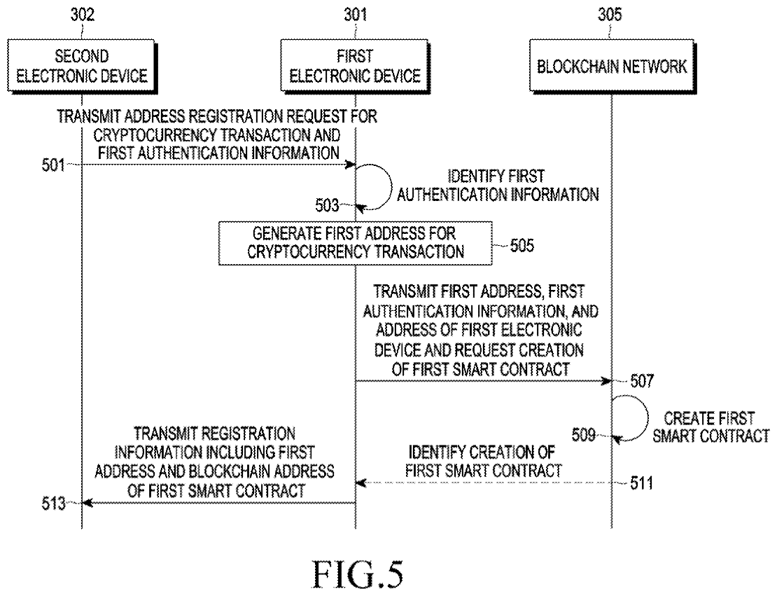

FIG. 5 is a view illustrating a method in which a first electronic device creates a first smart contract on a blockchain network, according to one or more embodiments.

According to one or more embodiments, in operation 501, a second electronic device (e.g., the second electronic device 302 of FIG. 3, an active role (AR) device, or a device requesting cryptocurrency transaction) may transmit a registration request for an address for cryptocurrency transaction and first authentication information of the second electronic device 302 to a first electronic device (e.g., the first electronic device 301 of FIG. 3, a support role (SR) device, or a device generating an address for cryptocurrency transaction).

According to one or more embodiments, in operation 503, the first electronic device 301 may identify the first authentication information of the second electronic device 302.

According to one or more embodiments, in operation 505, the first electronic device 301 may generate a first address for cryptocurrency transaction of the second electronic device 302 when the first authentication information is identified.

According to one or more embodiments, in operation 507, the first electronic device 301 may transmit the first address, the first authentication information, and the address of the first electronic device 301 to the blockchain network 305. Further, the first electronic device 301 may request creation of the first smart contract 310 configured to perform a cryptocurrency wallet function on the blockchain network 305 while transmitting the first address, the first authentication information, and the address of the first electronic device 301.

According to one or more embodiments, in operation 509, the blockchain network 305 (or nodes included in the blockchain network 305) may create the first smart contract 310. For example, the operation of creating the first smart contract may include an operation in which information on the first smart contract is stored in nodes included in the blockchain network 305. When the first smart contract 310 is created, a blockchain address for initiating cryptocurrency transaction using the first smart contract 310 may also be created.

According to one or more embodiments, in operation 511, the first electronic device 301 may identify that the first smart contract 310 is created. Further, the first electronic device 301 may identify the blockchain address of the first smart contract 310.

According to one or more embodiments, in operation 513, the first electronic device 301 may transmit registration information including the first address and the blockchain address of the first smart contract 310 to the second electronic device 302. Thereafter, the second electronic device 302 may perform an operation related to cryptocurrency transaction using the first address. Further, the second electronic device 302 may inquire or identify information on cryptocurrency assets (e.g., balance, quantity, type, and/or transaction history) using the blockchain address of the first smart contract 310.

According to the above-described method, the first electronic device 301 may create the first smart contract 310 configured to perform a cryptocurrency wallet function on the blockchain network 305. In other words, the first electronic device 301 may create the first smart contract 310 on the blockchain network 305 through which the second electronic device 302 may initiate cryptocurrency transaction without security information (e.g., private key). Accordingly, the second electronic device 302 may initiate cryptocurrency transaction without security information (e.g., private key).

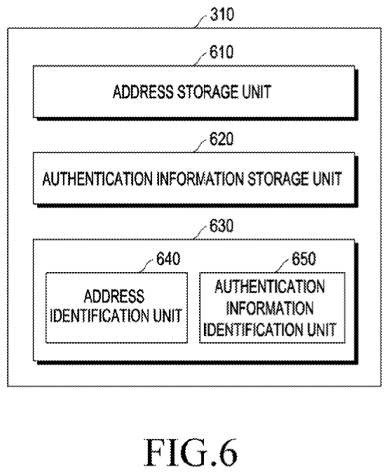

FIG. 6 is a view illustrating a first smart contract configured to perform a wallet function, according to one or more embodiments.

Referring to FIG. 6, according to one or more embodiments, the first smart contract 310 may include a smart contract configured to perform a blockchain electronic wallet (e.g., cold wallet) function. For example, the first smart contract 310 may include codes configured to perform a function related to cryptocurrency transaction. Further, the first smart contract 310 may store data (e.g., a whitelist address, authentication information for cryptocurrency transaction) for performing a function related to cryptocurrency transaction.

According to one or more embodiments, the first smart contract 310 may include an address storage unit 610, an authentication information storage unit 620, and a processing unit 630. For example, each of the address storage unit 610, the authentication information storage unit 620, and the processing unit 630 may be a set of codes.

According to one or more embodiments, the address storage unit 610 may store the first address and the address of the first electronic device 301 received from a first electronic device (e.g., the first electronic device 301 of FIG. 3). For example, the addresses stored in the address storage unit 610 may be addresses corresponding to a whitelist. The first smart contract 310 may perform only functions related to cryptocurrency transaction requested by electronic devices corresponding to the addresses stored in the address storage unit 610.

According to one or more embodiments, the authentication information storage unit 620 may store authentication information (hereinafter, first authentication information) of the second electronic device (e.g., the second electronic device 302 of FIG. 3) received from a first electronic device (e.g., the first electronic device 301 of FIG. 3). The first smart contract 310 may perform a function related to cryptocurrency transaction requested by an electronic device corresponding to the authentication information stored in the authentication information storage unit 620.

According to one or more embodiments, the processing unit 630 may identify whether an address and authentication information requesting cryptocurrency transaction match information pre-stored in the address storage unit 610 and the authentication information storage unit 620.

According to one or more embodiments, the processing unit 630 may include an address identification unit 640 and an authentication information identification unit 650.

According to one or more embodiments, the address identification unit 640 may identify whether an address of the first electronic device 301 or the second electronic device 302 requesting a new transaction matches an address stored in the address storage unit 610. The processing unit 630 may perform functions related to cryptocurrency transaction requested by the electronic device when it is identified that the address of the first electronic device 301 or the second electronic device 302 matches the address stored in the address storage unit 610. On the other hand, the processing unit 630 may not perform functions related to cryptocurrency transaction requested by the electronic device when the addresses do not match.

According to one or more embodiments, the authentication information identification unit 650 may identify whether authentication information received from the second electronic device 302 requesting initiation of a new transaction (or transaction) matches an address stored in the authentication information storage unit 620. The processing unit 630 may perform functions related to cryptocurrency transaction requested by the second electronic device 302 when it is identified that the authentication information received from the second electronic device 302 matches the address stored in the authentication information storage unit 620. On the other hand, the processing unit 630 may not perform functions related to cryptocurrency transaction requested by the electronic device when the authentication information does not match.

According to one or more embodiments, the processing unit 630 may initiate a new transaction (or transaction) on the blockchain network 305 using the blockchain address designated to the first smart contract 310 when it is identified that both the addresses and the authentication information match. In this case, the processing unit 630 may initiate a new transaction (or transaction) on the blockchain network 305 by writing a signature based on the private key of the first smart contract 310 in the transaction information received from the second electronic device 302.

According to the above-described method, the second electronic device 302 may initiate cryptocurrency transaction on the blockchain network 305 using the first smart contract 310.

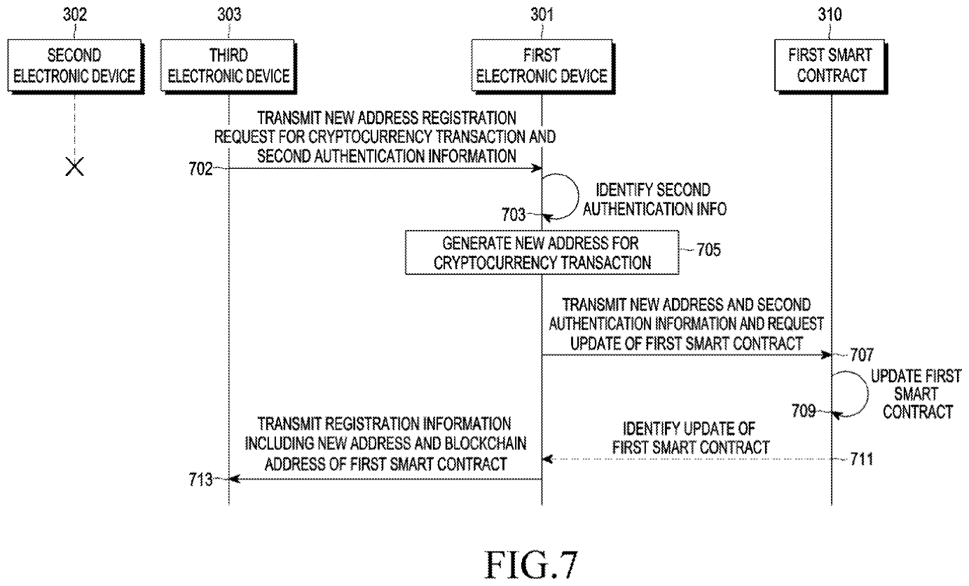

FIG. 7 is a flowchart illustrating a method in which a first electronic device adds an address of a new electronic device for transacting cryptocurrency using a first smart contract to the first smart contract, according to one or more embodiments.

According to one or more embodiments, when a second electronic device (e.g., the second electronic device 302 of FIG. 3) is lost or initialized, a new third electronic device 303 may be determined as an electronic device for cryptocurrency transaction (e.g., an active role (AR) device). For example, the third electronic device 303 may be implemented identically or similarly to the electronic device 101, 102, or 104 of FIG. 1.

According to one or more embodiments, in operation 702, the third electronic device 303 may transmit a registration request for a new address for cryptocurrency transaction and second authentication information of the third electronic device 303 to a first electronic device (e.g., the first electronic device 301 of FIG. 3, a support role (SR) device). For example, the second authentication information may include information for authenticating or identifying the third electronic device 303.

According to one or more embodiments, in operation 703, the first electronic device 301 may identify the second authentication information of the third electronic device 303.

According to one or more embodiments, in operation 705, the first electronic device 301 may generate a new address (hereinafter, second address) for cryptocurrency transaction of the third electronic device 303 when the second authentication information is identified. For example, a method of generating the second address may be implemented identically or similarly to a method of generating the first address.

According to one or more embodiments, in operation 707, the first electronic device 301 may transmit the second address and the second authentication information to the blockchain network 305. According to the implementation, the first electronic device 301 may also transmit the address of the first electronic device 301 to the blockchain network 305. The first electronic device 301 may request update (or addition) of the second address and the second authentication information to the first smart contract 310 while transmitting the second address, the second authentication information (and the address of the first electronic device 301).

According to one or more embodiments, in operation 709, the blockchain network 305 (or nodes included in the blockchain network 305) may update (or add) the second address and the second authentication information in the first smart contract 310. For example, the first smart contract 310 may store the second address in the address storage unit (e.g., the address storage unit 610 of FIG. 6) and store the second authentication information in the authentication information storage unit (e.g., the authentication information storage unit 620 of FIG. 6).

According to one or more embodiments, in operation 711, the first electronic device 301 may identify that the first smart contract 310 is updated. For example, the first electronic device 301 may identify that the first smart contract 310 is updated by accessing the blockchain network 305. Alternatively, the first electronic device 301 may identify that the first smart contract 310 is updated through information indicating that the first smart contract 310 is updated received from the blockchain network 305.

According to one or more embodiments, in operation 713, the first electronic device 301 may transmit registration information including the second address and the blockchain address of the first smart contract 310 to the third electronic device 303. Thereafter, the third electronic device 303 may perform an operation related to cryptocurrency transaction using the second address. Further, the third electronic device 303 may inquire or identify information on cryptocurrency assets (e.g., balance, quantity, type, and/or transaction history) using the blockchain address of the first smart contract 310.

According to another embodiment, when the second electronic device 302 is initialized, the existing second electronic device 302 may also be determined as an electronic device for cryptocurrency transaction. The second electronic device 302 may transmit a registration request for a new address for cryptocurrency transaction and authentication information (e.g., first authentication information or new authentication information) of the second electronic device 302 to the first electronic device 301. The first electronic device 301 may generate a new address for cryptocurrency transaction of the second electronic device 302 when the authentication information of the second electronic device 302 is identified. The first electronic device 301 may transmit the new address and the authentication information to the blockchain network 305. The first electronic device 301 may request update (or addition) of the new address and the authentication information to the first smart contract 310 while transmitting the new address and the authentication information. The first electronic device 301 may transmit registration information including the new address and the blockchain address of the first smart contract 310 to the second electronic device 302 when it is identified that the first smart contract 310 is updated. Thereafter, the second electronic device 302 may perform an operation related to cryptocurrency transaction using the new address.

According to the above-described method, even when the second electronic device 302 is lost or initialized, the first electronic device 301 may transmit a new address for management or transaction of cryptocurrency to an existing device (e.g., the second electronic device 302) or a new device (e.g., the third electronic device 303). Accordingly, even without security information (e.g., private key), the user may manage cryptocurrency assets using an existing electronic device (e.g., the second electronic device 302) or a new electronic device (e.g., the third electronic device 303).

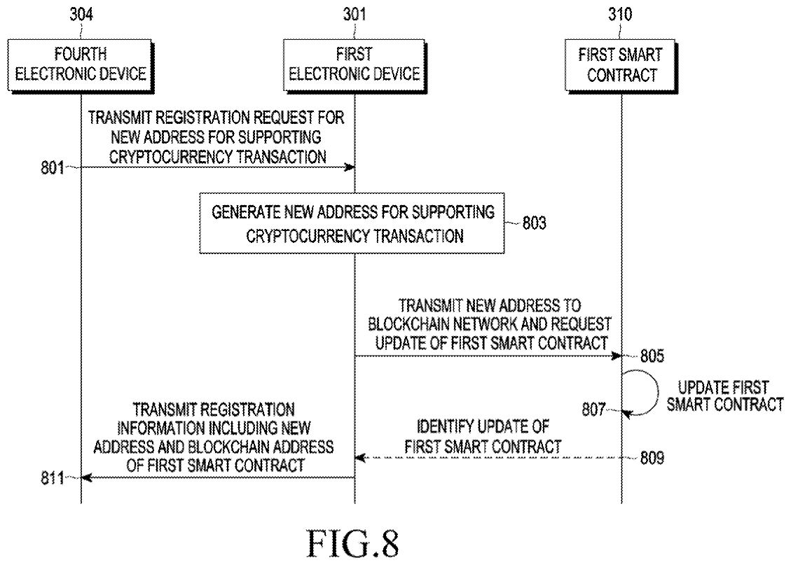

FIG. 8 is a flowchart illustrating a method in which a first electronic device adds an address of a new electronic device supporting cryptocurrency transaction to a first smart contract, according to one or more embodiments.

According to one or more embodiments, a new fourth electronic device 304 may be determined as an electronic device for supporting cryptocurrency transaction (e.g., a support role (SR) device). For example, the fourth electronic device 304 may be implemented identically or similarly to the electronic device 101, 102, or 104 of FIG. 1.

According to one or more embodiments, in operation 801, the fourth electronic device 304 may transmit a registration request for a new address for supporting cryptocurrency transaction to a first electronic device (e.g., the first electronic device 301 of FIG. 3, a support role (SR) device).

According to one or more embodiments, in operation 803, the first electronic device 301 may generate a new address (hereinafter, third address) for supporting cryptocurrency transaction of the fourth electronic device 304. For example, a method of generating the third address may be implemented identically or similarly to a method of generating the first address.

According to one or more embodiments, in operation 805, the first electronic device 301 may transmit the third address to the blockchain network 305. According to the implementation, the first electronic device 301 may also transmit the address of the first electronic device 301 to the blockchain network 305. The first electronic device 301 may request update (or addition) of the third address to the first smart contract 310 while transmitting the third address (and the address of the first electronic device 301).

According to one or more embodiments, in operation 807, the blockchain network 305 (or nodes included in the blockchain network 305) may update (or add) the third address in the first smart contract 310. For example, the first smart contract 310 may store the third address in the address storage unit (e.g., the address storage unit 610 of FIG. 6).

According to one or more embodiments, in operation 809, the first electronic device 301 may identify that the first smart contract 310 is updated. For example, the first electronic device 301 may identify that the first smart contract 310 is updated by accessing the blockchain network 305. Alternatively, the first electronic device 301 may identify that the first smart contract 310 is updated through information indicating that the first smart contract 310 is updated received from the blockchain network 305.

According to one or more embodiments, in operation 811, the first electronic device 301 may transmit registration information including the third address to the fourth electronic device 304. Thereafter, the fourth electronic device 304 may perform an operation related to supporting cryptocurrency transaction using the third address.

According to one or more embodiments, when the third address of the fourth electronic device 304 is added to the first smart contract, both the first electronic device 301 and the fourth electronic device 304 may perform an operation related to supporting cryptocurrency transaction. Alternatively, according to implementation, when the third address of the fourth electronic device 304 is added to the first smart contract, the first smart contract 310 may also delete the address of the first electronic device 301 from the address storage unit 610 so that only the fourth electronic device 304 performs an operation related to supporting cryptocurrency transaction.

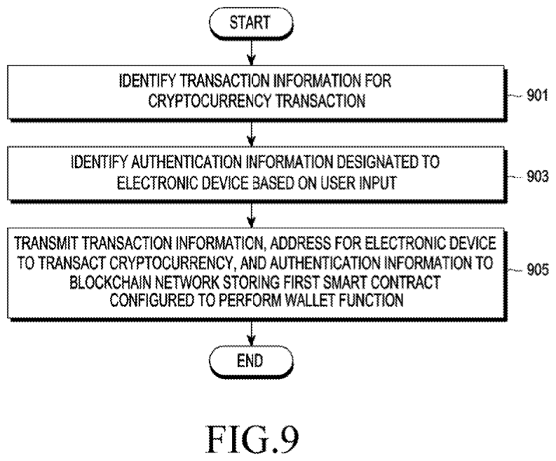

FIG. 9 is a flowchart illustrating a method in which a second electronic device transacts cryptocurrency using a first smart contract, according to one or more embodiments.

According to one or more embodiments, a second electronic device (e.g., the second electronic device 302 of FIG. 3) may initiate a new cryptocurrency transaction after receiving the first address and the blockchain address of the first smart contract.

According to one or more embodiments, in operation 901, the second electronic device 302 may identify transaction information for cryptocurrency transaction. For example, the transaction information may include information on a blockchain address of a counterpart transacting cryptocurrency, a quantity of cryptocurrency to be transacted, and/or a type of cryptocurrency. The second electronic device 302 may identify the transaction information based on a message received from outside. Alternatively, the second electronic device 302 may also identify the transaction information based on a user input.

According to one or more embodiments, in operation 903, the second electronic device 302 may identify authentication information designated to the second electronic device 302 based on a user input. For example, the authentication information may include a designated value (e.g., a PIN number), a designated pattern, and/or biometric information of the user.

According to one or more embodiments, in operation 905, the second electronic device 302 may transmit the transaction information, the first address for the electronic device to transact cryptocurrency, and authentication information of the first electronic device to a blockchain network (e.g., the blockchain network 305 of FIG. 3) storing a first smart contract (e.g., the first smart contract 310 of FIG. 3) configured to perform a wallet function. For example, the second electronic device 302 may request initiation of a new transaction on the blockchain network 305 by transmitting transaction information including the transaction information and the first address and authentication information of the first electronic device to the blockchain network 305.

According to one or more embodiments, at least one node (e.g., a pre-designated node or a builder node) among nodes included in the blockchain network 305 may call the first smart contract 310 upon identifying the transaction information. The first smart contract 310 may add or store a new block recording the transaction information in nodes included in the blockchain network 305 when it is identified that the authentication information received from the second electronic device matches pre-stored authentication information. In this case, the first smart contract 310 may add or store the new block recording the transaction information in nodes included in the blockchain network 305 using the blockchain address of the first smart contract 310 and a signature based on the private key of the first smart contract 310. When the transaction information is stored in nodes included in the blockchain network 305, the cryptocurrency transaction corresponding to the transaction information may be completed.

Through the above-described method, the second electronic device 302 may initiate a new cryptocurrency transaction on the blockchain network 305 using the first smart contract 310.

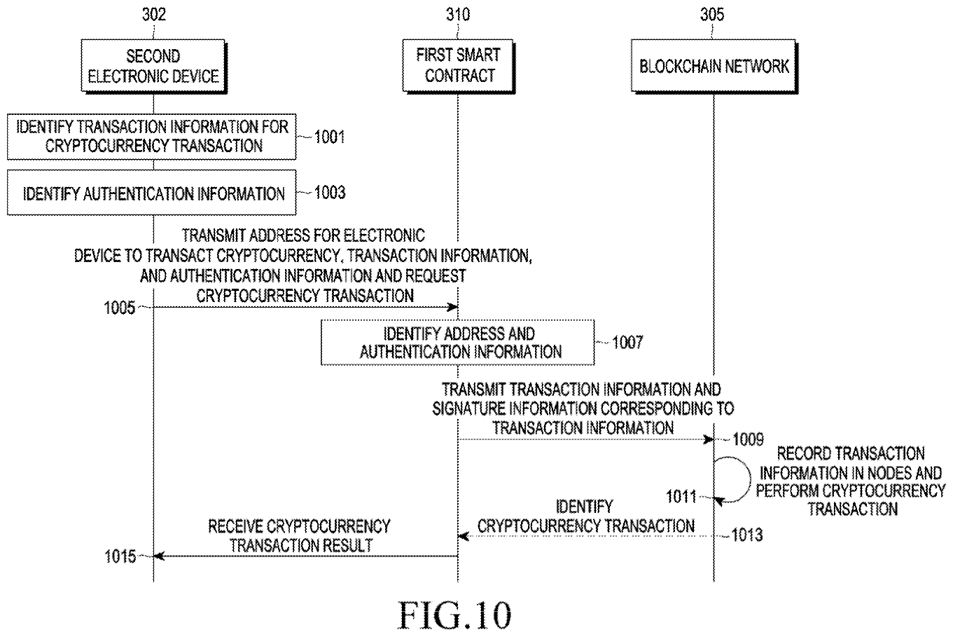

FIG. 10 is a view illustrating a method in which a second electronic device transacts cryptocurrency using a first smart contract, according to one or more embodiments.

Referring to FIG. 10, according to one or more embodiments, in operation 1001, the second electronic device 302 may identify transaction information for cryptocurrency transaction. For example, the transaction information may include information on a blockchain address of a counterpart transacting cryptocurrency, a quantity of cryptocurrency to be transacted, and/or a type of cryptocurrency.

According to one or more embodiments, in operation 1003, the second electronic device 302 may identify authentication information based on a user input.

According to one or more embodiments, in operation 1005, the second electronic device 302 may request initiation of a new cryptocurrency transaction on the blockchain network 305 by providing an address for the second electronic device 302 to transact cryptocurrency, the transaction information, and the authentication information to the first smart contract 310.

According to one or more embodiments, in operation 1007, the first smart contract 310 may identify the address and the authentication information provided by the second electronic device 302. For example, the first smart contract 310 may identify whether the address and the authentication information provided by the second electronic device 302 match pre-stored information.

According to one or more embodiments, in operation 1009, the first smart contract 310 may transmit transaction information corresponding to the transaction information and signature information of the first smart contract 310 to the blockchain network 305 (or nodes included in the blockchain network 305) when it is identified that the address and the authentication information provided by the second electronic device 302 match information pre-stored in the first smart contract 310.

According to one or more embodiments, in operation 1011, the blockchain network 305 (or nodes included in the blockchain network 305) may perform cryptocurrency transaction by recording a new block including the transaction information.

According to one or more embodiments, in operation 1013, the first smart contract 310 may identify completion of cryptocurrency transaction. According to one or more embodiments, in operation 1015, the second electronic device 302 may receive information indicating a cryptocurrency transaction result (or information indicating completion of transaction) from the first smart contract 310.

Through the above-described method, the second electronic device 302 may initiate a new cryptocurrency transaction on the blockchain network 305 using the first smart contract 310. Further, even without storing and using security information (e.g., private key) by itself, the second electronic device 302 may initiate a new cryptocurrency transaction on the blockchain network 305 using the first smart contract 310. Accordingly, even when the private key is lost or leaked, the second electronic device 302 may manage and transact cryptocurrency assets.

According to one or more embodiments, a first electronic device 301 may include a communication circuitry 340, at least one processor 320, and memory 330 storing instructions. According to one or more embodiments, the instructions may, when executed by the at least one processor individually or collectively, cause the electronic device to receive, through the communication circuitry, a first registration request for an address for cryptocurrency transaction and first authentication information of the second electronic device from a second electronic device 302. According to one or more embodiments, the instructions may, when executed by the at least one processor individually or collectively, cause the electronic device to generate a first address for the second electronic device to transact the cryptocurrency, based on receiving the first registration request and the first authentication information. According to one or more embodiments, the instructions may, when executed by the at least one processor individually or collectively, cause the electronic device to transmit first transaction information including the first address, the first authentication information, and an address of the first electronic device for supporting cryptocurrency transaction to the blockchain network through the communication circuitry to create a first smart contract 310 configured to perform a wallet function on a blockchain network 305. According to one or more embodiments, the instructions may, when executed by the at least one processor individually or collectively, cause the electronic device to transmit registration information including the first address and a blockchain address of the first smart contract to the second electronic device through the communication circuitry, based on identifying that the first smart contract has been created on the blockchain network.

According to one or more embodiments, the instructions may, when executed by the at least one processor individually or collectively, cause the electronic device to identify the address of the first electronic device, based on receiving the registration request from a first electronic device through the communication circuitry.

According to one or more embodiments, the instructions may, when executed by the at least one processor individually or collectively, cause the electronic device to generate the first address based on an address format of the blockchain network.

According to one or more embodiments, the first address may be different from the address of the first smart contract.

According to one or more embodiments, the first smart contract may store the first address and the first authentication information.

According to one or more embodiments, the instructions may, when executed by the at least one processor individually or collectively, cause the electronic device to receive, through the communication circuitry, a second registration request for a new address for cryptocurrency transaction and second authentication information of the second electronic device from a second electronic device. According to one or more embodiments, the instructions may, when executed by the at least one processor individually or collectively, cause the electronic device to generate a second address for the second electronic device to transact the cryptocurrency, based on receiving the second registration request and the second authentication information. According to one or more embodiments, the instructions may, when executed by the at least one processor individually or collectively, cause the electronic device to transmit the second address and the second authentication information to the blockchain network through the communication circuitry to update the second address and the second authentication information in the first smart contract. According to one or more embodiments, the instructions may, when executed by the at least one processor individually or collectively, cause the electronic device to transmit registration information including the second address and the blockchain address of the first smart contract to the second electronic device through the communication circuitry, based on identifying that the second address and the second authentication information have been updated in the first smart contract.

According to one or more embodiments, the instructions may, when executed by the at least one processor individually or collectively, cause the electronic device to receive, through the communication circuitry, a third registration request for a new address for cryptocurrency transaction and third authentication information of the third electronic device from a third electronic device 303. According to one or more embodiments, the instructions may, when executed by the at least one processor individually or collectively, cause the electronic device to generate a third address for the third electronic device to transact the cryptocurrency, based on receiving the third registration request and the third authentication information. According to one or more embodiments, the instructions may, when executed by the at least one processor individually or collectively, cause the electronic device to transmit the third address and the third authentication information to the blockchain network through the communication circuitry to update the third address and the third authentication information in the first smart contract. According to one or more embodiments, the instructions may, when executed by the at least one processor individually or collectively, cause the electronic device to transmit registration information including the third address and the blockchain address of the first smart contract to the third electronic device through the communication circuitry, based on identifying that the third address and the third authentication information have been updated in the first smart contract.

According to one or more embodiments, the instructions may, when executed by the at least one processor individually or collectively, cause the electronic device to transmit information on the address of the first electronic device to the blockchain network to update the third address and the third authentication information in the first smart contract.

According to one or more embodiments, the instructions may, when executed by the at least one processor individually or collectively, cause the electronic device to receive, through the communication circuitry, a fourth registration request for a new address for cryptocurrency recovery from a fourth electronic device 304. According to one or more embodiments, the instructions may, when executed by the at least one processor individually or collectively, cause the electronic device to generate a fourth address for the fourth electronic device to recover the cryptocurrency, based on receiving the fourth registration request. According to one or more embodiments, the instructions may, when executed by the at least one processor individually or collectively, cause the electronic device to transmit transaction information including the fourth address to the blockchain network through the communication circuitry to update the fourth address in the first smart contract. According to one or more embodiments, the instructions may, when executed by the at least one processor individually or collectively, cause the electronic device to transmit registration information including the fourth address and the blockchain address of the first smart contract to the fourth electronic device through the communication circuitry, based on identifying that the fourth address has been updated in the first smart contract.

According to one or more embodiments, a method of operating a first electronic device 301 may include an operation of receiving a first registration request for an address for cryptocurrency transaction and first authentication information of the second electronic device from a second electronic device 302. According to one or more embodiments, the method of operating the first electronic device may include an operation of generating a first address for the second electronic device to transact the cryptocurrency, based on receiving the first registration request and the first authentication information. According to one or more embodiments, the method of operating the first electronic device may include an operation of transmitting transaction information including the first address, the first authentication information, and an address of the first electronic device for supporting cryptocurrency transaction to the blockchain network to create a first smart contract 310 configured to perform a wallet function on a blockchain network 305. According to one or more embodiments, the method of operating the first electronic device may include an operation of transmitting registration information including the first address and a blockchain address of the first smart contract to the second electronic device, based on identifying that the first smart contract has been created on the blockchain network.

According to one or more embodiments, the method of operating the first electronic device may further include an operation of identifying the second address, based on receiving the registration request from a first electronic device.

According to one or more embodiments, the operation of generating the first address may include an operation of generating the first address based on an address format of the blockchain network.

According to one or more embodiments, the method of operating the first electronic device may further include an operation of receiving a second registration request for a new address for cryptocurrency transaction and second authentication information of the second electronic device from a second electronic device. According to one or more embodiments, the method of operating the first electronic device may further include an operation of generating a second address for the second electronic device to transact the cryptocurrency, based on receiving the second registration request and the second authentication information. According to one or more embodiments, the method of operating the first electronic device may further include an operation of transmitting transaction information including the second address and the second authentication information to the blockchain network to update the second address and the second authentication information in the first smart contract. According to one or more embodiments, the method of operating the first electronic device may further include an operation of transmitting registration information including the second address and the blockchain address of the first smart contract to the second electronic device, based on identifying that the second address and the second authentication information have been updated in the first smart contract.

According to one or more embodiments, the method of operating the first electronic device may further include an operation of receiving a third registration request for a new address for cryptocurrency transaction and third authentication information of the third electronic device from a third electronic device 303. According to one or more embodiments, the method of operating the first electronic device may further include an operation of generating a third address for the third electronic device to transact the cryptocurrency, based on receiving the third registration request and the third authentication information. According to one or more embodiments, the method of operating the first electronic device may further include an operation of transmitting transaction information including the third address and the third authentication information to the blockchain network to update the third address and the third authentication information in the first smart contract. According to one or more embodiments, the method of operating the first electronic device may further include an operation of transmitting registration information including the third address and the blockchain address of the first smart contract to the third electronic device through the communication circuitry, based on identifying that the third address and the third authentication information have been updated in the first smart contract.

According to one or more embodiments, the method of operating the first electronic device may further include an operation of receiving a fourth registration request for a new address for cryptocurrency recovery from a fourth electronic device 304. According to one or more embodiments, the method of operating the first electronic device may further include an operation of generating a fourth address for the fourth electronic device to recover the cryptocurrency, based on receiving the fourth registration request. According to one or more embodiments, the method of operating the first electronic device may further include an operation of transmitting transaction information including the fourth address to the blockchain network to update the fourth address in the first smart contract. According to one or more embodiments, the method of operating the first electronic device may further include an operation of transmitting registration information including the fourth address and the blockchain address of the first smart contract to the fourth electronic device, based on identifying that the fourth address has been updated in the first smart contract.

According to one or more embodiments, an electronic device 302 may include memory 380, communication circuitry 390, and a processor 370. According to one or more embodiments, the processor may be configured to identify transaction information for cryptocurrency transaction. According to one or more embodiments, the processor may be configured to identify authentication information designated to the electronic device based on a user input. According to one or more embodiments, the processor may be configured to transmit the transaction information, an address for the electronic device to transact the cryptocurrency, and the authentication information to a blockchain network 305 storing a first smart contract 310 configured to perform a wallet function. According to one or more embodiments, when the address of the electronic device and the authentication information are identified by the first smart contract to match information pre-stored in the first smart contract, the cryptocurrency transaction may be completed by the smart contract. According to one or more embodiments, the cryptocurrency transaction may be performed based on the blockchain address and a private key of the smart contract.

According to one or more embodiments, the transaction information may include information on a blockchain address of a counterpart transacting cryptocurrency, a quantity of cryptocurrency to be transacted, and/or a type of cryptocurrency.

According to one or more embodiments, the address of the electronic device and the blockchain address may be different.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1440) including one or more instructions that are stored in a storage medium (e.g., internal memory 1436 or external memory 1438) that is readable by a machine (e.g., the electronic device 1401). For example, a processor (e.g., the processor 1420) of the machine (e.g., the electronic device 1401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A first electronic device, comprising:
communication circuitry;
at least one processor; and
memory storing instructions, wherein the instructions, when executed by the at least one processor individually or collectively, cause the electronic device to:
receive from a second electronic device, through the communication circuitry, a first registration request for an address associated with a cryptocurrency transaction and first authentication information of the second electronic device;
generate a first address associated with the second electronic device to transact cryptocurrency, based on receiving the first registration request and the first authentication information;
transmit, through the communication circuitry to a blockchain network, first transaction information comprising the first address, the first authentication information, and an address associated with the first electronic device for supporting the cryptocurrency transaction, wherein the first transaction information is used to create a first smart contract configured to perform a wallet function on the blockchain network; and
transmit registration information comprising the first address and a blockchain address of the first smart contract to the second electronic device through the communication circuitry, based on identifying that the first smart contract has been created on the blockchain network.

2. The electronic device of claim 1, wherein the instructions, when executed by the at least one processor individually or collectively, cause the first electronic device to identify the address associated with the first electronic device, based on receiving the first registration request.

3. The electronic device of claim 1, wherein the instructions, when executed by the at least one processor individually or collectively, cause the first electronic device to generate the first address based on an address format associated with the blockchain network.

4. The electronic device of claim 1, wherein the first address is different from an address associated with the first smart contract.

5. The electronic device of claim 1, wherein the first smart contract is configured to store the first address and the first authentication information.

6. The electronic device of claim 1, wherein the instructions, when executed by the at least one processor individually or collectively, cause the first electronic device to:
receive from the second electronic device, through the communication circuitry, a second registration request for a new address associated with cryptocurrency transaction and second authentication information of the second electronic device;
generate a second address associated with the second electronic device to transact the cryptocurrency, based on receiving the second registration request and the second authentication information;
transmit the second address and the second authentication information to the blockchain network through the communication circuitry to update the second address and the second authentication information in the first smart contract; and
transmit registration information comprising the second address and the blockchain address associated with the first smart contract to the second electronic device through the communication circuitry, based on identifying that the second address and the second authentication information have been updated in the first smart contract.

7. The electronic device of claim 1, wherein the instructions, when executed individually or collectively by the at least one processor, cause the first electronic device to:
receive from a third electronic device, through the communication circuitry, a third registration request for a new address associated with a cryptocurrency transaction and third authentication information of the third electronic device;
generate a third address associated with the third electronic device to transact the cryptocurrency, based on receiving the third registration request and the third authentication information;
transmit the third address and the third authentication information to the blockchain network through the communication circuitry to update the third address and the third authentication information in the first smart contract; and
transmit registration information comprising the third address and the blockchain address associated with the first smart contract to the third electronic device through the communication circuitry, based on identifying that the third address and the third authentication information have been updated in the first smart contract.

8. The electronic device of claim 7, wherein the instructions, when executed by the at least one processor individually or collectively, cause the first electronic device to transmit information on the address associated with the first electronic device to the blockchain network to update the third address and the third authentication information in the first smart contract.

9. The electronic device of claim 1, wherein the instructions, when executed by the at least one processor individually or collectively, cause the first electronic device to:
receive from a fourth electronic device, through the communication circuitry, a fourth registration request for a new address associated with cryptocurrency recovery;
generate a fourth address associated with the fourth electronic device to recover the cryptocurrency, based on receiving the fourth registration request;
transmit transaction information comprising the fourth address to the blockchain network through the communication circuitry to update the fourth address in the first smart contract; and
transmit registration information comprising the fourth address and the blockchain address associated with the first smart contract to the fourth electronic device through the communication circuitry, based on identifying that the fourth address has been updated in the first smart contract.

10. A method of operating a first electronic device, comprising:
receiving from a second electronic device a first registration request for an address associated with a cryptocurrency transaction and first authentication information of the second electronic device;
generating a first address associated with the second electronic device to transact cryptocurrency, based on receiving the first registration request and the first authentication information;
transmitting transaction information comprising the first address, the first authentication information, and an address associated with the first electronic device for supporting the cryptocurrency transaction to a blockchain network, wherein the transaction information is used to create a first smart contract configured to perform a wallet function on the blockchain network; and
transmitting registration information comprising the first address and a blockchain address associated with the first smart contract to the second electronic device, based on identifying that the first smart contract has been created on the blockchain network.

11. The method of claim 10, further comprising identifying the second address, based on receiving the registration request.

12. The method of claim 10, wherein generating the first address comprises generating the first address based on an address format associated with the blockchain network.

13. The method of claim 10, wherein the first address is different from the address associated with the first smart contract.

14. The method of claim 10, wherein the first smart contract is configured to store the first address and the first authentication information.

15. The method of claim 10, further comprising:
receiving from a second electronic device a second registration request for a new address associated with cryptocurrency transaction and second authentication information of the second electronic device ;
generating a second address associated with the second electronic device to transact the cryptocurrency, based on receiving the second registration request and the second authentication information;
transmitting transaction information including the second address and the second authentication information to the blockchain network to update the second address and the second authentication information in the first smart contract; and
transmitting registration information including the second address and the blockchain address associated with the first smart contract to the second electronic device, based on identifying that the second address and the second authentication information have been updated in the first smart contract.
